(19) United States
(12) Patent Application Publication
(10) Pub. No.: US 2009/0291367 A1
(43) Pub. Date: Nov. 26, 2009

(54) Lithium secondary battery and method of manufacturing same

(75) Inventors: Fuminori Mizuno, Susono-shi (JP); Noriyuki Sonoyama, Nagoya-shi (JP); Kunihiko Hara, Nukata-gun (JP)

Correspondence Address: OLIFF & BERRIDGE, PLC, P.O. BOX 320850, ALEXANDRIA, VA, 22320-4850, US

(73) Assignees: TOYOTA JIDOSHA KABUSHIKI KAISHA, Toyota-Shi (JP); GENESIS RESEARCH INSTITUTE, INC., Nagoya-Shi (JP)

(21) Appl. No.: 12/453,605

(22) Filed: May 15, 2009

(30) Foreign Application Priority Data
May 20, 2008 (JP) 2008-132322

(51) Int. Cl. H01M 4/58; H01M 4/50; H01M 4/52; H01M 4/82

(52) U.S. Cl. 429/224; 429/231.95; 429/231.3; 29/623.3; 29/623.1

(57) ABSTRACT

A lithium secondary battery includes a positive electrode made from a positive electrode active material and a semiconductor substrate that is directly laminated on the positive electrode. A charge carrier formed in the positive electrode active material when the lithium secondary battery is charged and a carrier of the semiconductor substrate are the same, and the semiconductor substrate is used as a collector.

### INCORPORATION BY REFERENCE

The disclosure of Japanese Patent Application No. 2008-132322 filed on May 20, 2008, including the specification, drawings and abstract is incorporated herein by reference in its entirety.

### BACKGROUND OF THE INVENTION

1. Field of the Invention

The invention relates to a lithium secondary battery and a method of manufacturing the lithium secondary battery, and more particularly to a lithium secondary battery in which the positive electrode composed of a positive electrode active material is directly laminated on a semiconductor substrate that serves as a collector.

2. Description of the Related Art

Rechargeable secondary batteries, which may be used as a power source, have been widely employed in recent years, following the spread of mobile devices. Improvements in performance and functionality of mobile devices also created a demand for secondary batteries that are smaller in size, weight, and thickness and have higher capacity. Lithium secondary batteries are secondary batteries meeting such requirements. Lithium secondary batteries that are presently used mainly employ lithium cobalt oxide as a positive electrode active material and a carbon material as a negative electrode active material. In addition to the positive electrode active material and negative electrode active material, the lithium secondary battery includes an electrolytic solution and a separator, or a solid electrolyte, a positive electrode collector, and a negative electrode collector as constituent elements. The storage capacity of a lithium secondary battery having such constituent elements is close to a limit and the capacity is difficult to increase significantly. Furthermore, in thin-film batteries used in electronic circuits, a limitation is placed on battery volume. As a result, the electrode layer thickness has to be reduced, thereby reduces battery capacity.

Accordingly, a variety of alternative materials have been considered for use as the positive electrode active material, negative electrode active material, electrolyte, and separator. For example, it has been suggested to use a lithium-containing transition metal compound such as lithium nickel oxide or lithium manganese oxide as a positive electrode active material, to introduce a specific porous layer of an inorganic material between a positive electrode or negative electrode and a separator, and to use an electrolytic solution that includes a specific electrolyte, but the performance level attained with a lithium secondary battery using a combination of lithium cobalt oxide and a carbon material may has not be greatly surpassed. An electrode structure has thus been suggested that includes metal collectors provided at both the positive electrode and the negative electrode of a secondary battery (Japanese Patent Application Publication No. 10-284130 (JP-A-10-284130), Japanese Patent No. 3989389, Journal of Power Sources, 168 (2007), pages 493 to 500).

JP-A-10-284130 describes a secondary battery of a semiconductor substrate mounting type in which thin-film electrodes and a solid electrolyte are mounted on a semiconductor substrate. In a specific example, a secondary battery is described in which a wiring electrode, a negative electrode, a solid electrolyte, a positive electrode, and a wiring electrode are laminated on a p-type or n-type silicon substrate.

Japanese Patent No. 3989389 describes a solid secondary battery in which a porous film formed by surface modification of a semiconductor element substrate is used as a negative electrode active material. In a specific example, a solid thin-film secondary battery is described in which a Si crystal substrate (semiconductor substrate), a porous silicon layer (negative electrode active material), a solid electrolyte, a positive electrode active material, and a collector electrode are laminated in the stated order.

Journal of Power Sources, 168 (2007), pages 493 to 500 describes an electrode body in which a LiCoO₂ active material is epitaxially grown on a Nb-doped SrTiO₃ substrate. The orientation of the LiCoO₂ active material is dependent on the SfriO₃ substrate and that the battery output may be increased by controlling the orientation of the LiCoO₂ active material.

However, in the secondary battery described in JP-A-10-284130, because the wiring electrode functions as a collector, a structure is obtained in which the collector is laminated on the semiconductor substrate and the energy density of the secondary battery is low. The structure described in Japanese Patent No. 3989389 relates to a negative electrode and cannot be directly applied to a positive electrode. As for the structure described in Journal of Power Sources, 168 (2007), pages 493 to 500, because a Nb-doped SrTiO₃ substrate is known to be an n-type semiconductor substrate, the electronic resistance of active material and collector changes in a case where electron conduction direction is inverted in charging and discharging. As a result, reversibility is insufficient. Thus, electronic resistance during charging of a semiconductor substrate and a positive electrode active material in a lithium secondary battery is high, and a lithium secondary battery having a positive electrode with a high energy density cannot be obtained.

### SUMMARY OF THE INVENTION

The invention provides a lithium secondary battery in which electronic resistance of a semiconductor substrate and a positive electrode active material is low and which has a positive electrode with a high energy density.

The first aspect of the invention relates to a lithium secondary battery. The lithium secondary battery includes a positive electrode made from a positive electrode active material and a semiconductor substrate that is directly laminated on the positive electrode, wherein a charge carrier formed in the positive electrode active material when the lithium secondary battery is charged and a carrier of the semiconductor substrate are the same, and the semiconductor substrate is used as a collector.

The second aspect of the invention relates to a method for manufacturing a lithium secondary battery. In the manufacturing method, the positive electrode is laminated on the semiconductor substrate, an electrolyte layer is laminated on the positive electrode, a negative electrode is laminated on the electrolyte layer, and a negative electrode collector is laminated on the negative electrode.

According to the first and second aspect, it is possible to provide a lithium secondary battery in which electronic resistance of a semiconductor substrate and a positive electrode active material is low and which has a positive electrode with a high energy density.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a graph showing a charge-discharge curve determined by constant-current charge-discharge measurements of the lithium secondary battery obtained in Example 1 of the embodiment of this invention;

FIG. 2 is a graph showing a charge-discharge curve determined by constant-current charge-discharge measurements of the lithium secondary battery obtained in Comparative Example 1; and

FIG. 3 is a graph showing a charge-discharge curve determined by constant-current charge-discharge measurements of the lithium secondary battery obtained in Comparative Example 2.

### DETAILED DESCRIPTION OF EMBODIMENTS

The example embodiments of the invention are described below.

(1) A lithium secondary battery in which a charge carrier formed in the positive electrode active material when the lithium secondary battery is charged and a carrier of the semiconductor substrate are of the p type.

(2) A lithium secondary battery in which a positive electrode active material is LiMn₂O₄, and a semiconductor substrate is a p type semiconductor.

(3) A lithium secondary battery in which a semiconductor substrate is a p-type silicon semiconductor.

An embodiment of the lithium secondary battery according to the invention includes a positive electrode made from a positive electrode active material and a semiconductor substrate that is directly laminated on the positive electrode, wherein a charge carrier formed in the positive electrode active material when the lithium secondary battery is charged and a carrier of the semiconductor substrate are the same, and the semiconductor substrate is used as a collector. In this embodiment, the charge carrier formed in the positive electrode active material when the lithium secondary battery is charged and the carrier of the semiconductor substrate are of a p type or a n type. In the example lithium secondary battery of this embodiment, the positive electrode including a positive electrode active material and the semiconductor substrate are a positive electrode that is of the p type during charging and a p-type semiconductor substrate respectively, and the positive electrode is directly laminated on the p-type semiconductor substrate.

In contrast, with a combination in which the positive electrode active material during charging is of the p type and the semiconductor substrate is the n type semiconductor, or a combination in which the positive electrode active material during charging is of the n type and the semiconductor substrate is the p type semiconductor, an electronic resistance of the semiconductor substrate and the positive electrode active material is high and, therefore, a lithium secondary battery having a positive electrode with a high energy density cannot be obtained.

As for specific combinations of the positive electrode active material and the semiconductor in the embodiment, the positive electrode active material may be, for example, LiCoO₂, the positive electrode active material Li₁₋ₓCoO₂ during charging is of the p type and the semiconductor substrate is the p type semiconductor. In the positive electrode active material LiCoO₂, an electron is pulled out from Co when the lithium secondary battery is charged, and the electron structure of the positive electrode active material Li₁₋ₓCoO₂ changes from Co³⁺ to Co⁴⁺ when the lithium secondary battery is charged. As a result, holes are present in the electron configuration, thereby inducing the formation of p-type carriers and p-type semiconductor properties are demonstrated.

In another specific example, a combination may be considered in which the positive electrode active material is LiMn₂O₄, the positive electrode active material Li₁₋ₓMn₂O₄ during charging is of the p type and the semiconductor substrate is a p type semiconductor substrate. When LiMn₂O₄ is used as the positive electrode active material, an electron is pulled out from Mn when the lithium secondary battery is charged, and the electron structure of the positive electrode active material Li₁₋ₓMn₂O₄ changes from Mn³⁺ to Mn⁴⁺ when the lithium secondary battery is charged. As a result, holes are present in the electron configuration, thereby inducing the formation of p-type carriers and p-type semiconductor properties are demonstrated.

In this embodiment, the p-type or n-type semiconductor is not particularly limited and a single-element semiconductor such as a p-type or n-type silicon semiconductor or germanium semiconductor, or compound semiconductors such as p-type or n-type GaAs, InP, GaN, ZnS, ZuSe, SiC, SiGe, and SiTiO₃ may be used. Usually, p-type or n-type silicon semiconductors are preferred because they are readily available and very stable substances. The p-type silicon semiconductors may be obtained by doping silicon with small amount of a trivalent element such as boron. Furthermore, the n-type silicon semiconductors can be obtained by doping silicon with small amount of a pentavalent element such as arsenic or phosphorus. The thickness of the semiconductor substrate in this embodiment varies depending on the utilizing purpose of the secondary battery, but is generally equal to or less than 1 mm.

The direct lamination of the positive electrode composed of a positive electrode active material and the semiconductor substrate serving as a collector in the present embodiment can be performed; for example by forming a thin film of a positive electrode active material that is of the p type during charging on a p-type semiconductor substrate, or a thin film of a positive electrode active material that is of the n type during charging on an n-type semiconductor substrate. Examples of methods suitable for forming the thin film include sputtering, reactive deposition, vacuum vapor deposition, chemical vapor deposition, spraying, and plating. In particular PLD (Pulsed Laser Deposition) may be used. In this thin film formation method, a high-power pulsed laser is used. Specific features of the PLD method include easy composition control (because of a little difference between the compositions of target and thin film), the possibility of forming the film at a low temperature, easy film formation control, and a low level of contamination.

The formation of a thin film by the PLD method may be performed on the p-type semiconductor substrate by using a positive electrode active material that is of the p type during charging as a target, or on the n-type semiconductor substrate by using a positive electrode active material that is of the n type during charging as a target. In this embodiment, it is preferred that a thin film of the positive electrode active material on the semiconductor substrate be sintered simultaneously with the formation process or thereafter. As for sintering conditions, it is preferred that the substrate be heated in an argon atmosphere or air for 1 hour to 1 day at 650° C. to 800° C., preferably 700° C. to 800° C. The sintering increases crystallinity of the thin film of the positive electrode active material. In the thin film of the positive electrode active material thus formed, the diffusion ability of lithium ions becomes advantageously high with the decrease in film thickness, but taking the stability of performance into account, it is preferred that the thin film thickness be 0.1 μn to 100 μm, in particular 1 μm to 50 μm.

The lithium secondary battery of this embodiment may be obtained by successively laminating, for example, an electrolytic solution containing an organic solvent and a lithium salt and a separator or a solid electrolyte layer, a negative electrode, and a negative electrode collector.

The electrolytic solution is not particularly limited. For example, a nonaqueous electrolytic solution may be used that is prepared by dissolving an electrolyte, for example, LiClO₄, LiPF₆, LiAsF₆, LiBF₄, LiB(C₆H₅)₄, LiCl, LiBr, CH₃SO₃Li, and CF₃SO₃Li in an organic solvent such as ethylene carbonate (EC), dimethyl carbonate (DMC), diethyl carbonate (DEC), dipropyl carbonate (DPC), methyl propyl carbonate (MPC), ethyl propyl carbonate(EPC), ethyl methyl carbonate (EMC), propylene carbonate (PC), butylene carbonate (BC), dimethylsulfoxide (DMSO), sulfolane (SL), γ-butyrolactone (γ-BL), N,N-dimethylformamide (DMF), acetonitrile (ACN), N-methyl pyrrolidone (NMP), tetrahydrofuran (THF), or mixtures thereof. The separator that may be employed when the above-described electrolytic solutions are used is not particularly limited, and any separator that is able to separate the positive electrode and the negative electrode and retain the electrolytic solution may be employed. For example, porous films of polyethylene and polypropylene may be used.

No limitation is also placed in a case where a solid electrolyte is used. Thus, a laminate can be used that has a first layer of glass such as an active metal nitride, an active metal phosphate, an active metal halide, or an active metal phosphonitride and a second layer of a glassy or amorphous metal ion conductor, or ceramic active metal ion conductor, or a glass-ceramic active metal ion conductor in part thereof or in the entire structure. Alternatively, a gel-like polymer electrolyte containing a gel-like polymer and the above-described electrolytic solution may be used.

The negative electrode is not particularly limited. For example, a carbon negative electrode may be formed by bonding a layer of a negative electrode material including a negative electrode active material to a surface (one surface, preferably both surfaces) of a negative electrode collector manufactured from a metal film such as a Li metal (Li negative electrode) or copper. The negative electrode material bonded as a layer may be formed by preparing a paste by using a carbon material such as graphite or coke as a negative electrode active material, mixing it with a binder such as poly(vinylidene fluoride), and adding a solvent such as N-methyl-2-pyrrolidone, then coating the negative electrode paste on a surface of a negative electrode collector by using a coating apparatus or the like, and then drying. If necessary, the density of the negative electrode material may be increased by pressing or the like. The thickness of the negative electrode collector of a lithium secondary battery is typically 10 μm to 15 μm, and the thickness of the negative electrode material is 20 μm to 100 μm per one side.

The shape of the lithium secondary battery of this embodiment is not particularly limited and the battery may be cylindrical, coin-like, or laminated shape.

With this embodiment, by using a semiconductor substrate as a positive electrode collector, it is possible to produce a thin-film battery that is free of collector on the positive electrode side. Furthermore, the battery volume can be reduced and the battery capacity can be increased to a degree corresponding to a positive electrode collector (for example, 15 μm Al foil) if the semiconductor substrate and the positive electrode collector are separate components. In addition, the battery fabrication process is facilitated. With this embodiment, it is possible to obtain a thin-film battery in which the decrease in battery capacity is inhibited even if a thin-film battery for use in an electronic circuit. Even if a semiconductor substrate is used as a positive electrode collector, as described above, it is possible to realize a secondary battery that can be reversibly charged and discharged within a range of 3 to 4 V, as with the conventional batteries. Furthermore, because the positive electrode is directly laminated on the semiconductor substrate, the positive electrode can be sintered at a high temperature. Sintering the positive electrode at a high temperature is advantageous because a positive electrode with a high crystallinity (Li ions are easily introduced and desorbed) can be obtained.

Examples will be described below. The examples are merely illustrative and place no limitation on the invention. In the examples below Example 1, Comparative Example 1, and Comparative Example 2), the evaluation of lithium secondary battery was performed by constant-current charge-discharge measurements using a constant-current charge-discharge device (HA-501, manufactured by Hokuto Denko Corp.).

### EXAMPLE 1

### (1) Fabrication of Positive Electrode Thin Film

A thin film was fabricated on a p-type silicon semiconductor substrate by a PLD method under the following conditions using LiMn₂O₄ target as a positive electrode active material.

### (Film Fabrication Conditions)

Laser power: 180 mJ.
Atmosphere: O₂, 0.025 Torr.
Substrate temperature: 650° C.

### (2) Fabrication of lithium Secondary Battery

A lithium secondary battery having a p-type semiconductor substrate as a positive electrode collector was fabricated by successively laminating the below-described electrolytic solution, negative electrode, and negative electrode collector on a positive electrode composed of a positive electrode active material that was directly formed as a thin film on the obtained p-type silicon semiconductor substrate.
Electrolytic solution: 1M LiPF₆/PC.
Negative electrode: Li.
Negative electrode collector: Cu.

### (3) Electrochemical Evaluation

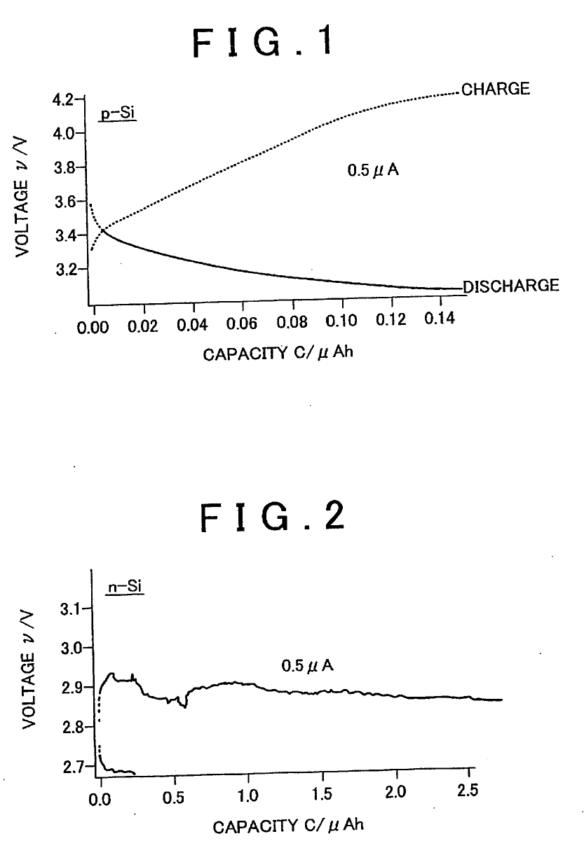

Evaluation was carried out by constant-current charge-discharge measurements (0.5 μA) by using the lithium secondary battery obtained. The obtained charge-discharge curve is shown in FIG. 1. In FIG. 1, the voltage v (V) is plotted on the ordinate, and the capacity C (μAh) is plotted on the abscissa.

### COMPARATIVE EXAMPLE 1

A positive electrode thin film composed of a positive electrode active material was fabricated by forming a thin film of LiMn₂O₄ directly on an n-type silicon semiconductor substrate in the same manner as in Example 1, except that the n-type silicon semiconductor substrate was used instead of the p-type silicon semiconductor substrate. A lithium secondary battery having the n-type silicon semiconductor substrate as a positive electrode collector was obtained in the same manner as in Example 1, except that this positive electrode thin film was used. Evaluation was carried out by constant-current charge-discharge measurements (0.5 μA) by using this lithium secondary battery. The obtained charge-discharge curve is shown in FIG. 2.

### COMPARATIVE EXAMPLE 2

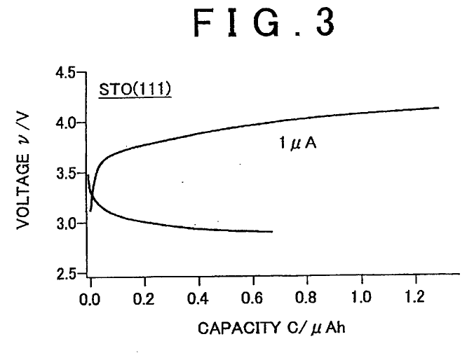

A positive electrode thin film composed of a positive electrode active material was fabricated by forming a thin film of LiMn₂O₄ directly on an n-type STO (SiTiO₃) semiconductor substrate in the same manner as in Example 1, except that the n-type STO semiconductor substrate was used instead of the p-type silicon semiconductor substrate. A lithium secondary battery having the n-type silicon semiconductor substrate as a positive electrode collector was obtained in the same manner as in Example 1, except that this positive electrode thin film was used. Evaluation was carried out by constant-current charge-discharge measurements (0.5 μA) by using this lithium secondary battery. The obtained charge-discharge curve is shown in FIG. 3.

FIG. 1 demonstrates that a lithium secondary battery in which a positive electrode active material that is of the p type when the lithium secondary battery is charged and a p-type semiconductor substrate are directly laminated and the p-type semiconductor substrate serves as a positive electrode collector has good charge-discharge characteristic and operating voltage. Furthermore, in FIG. 1, a linear smooth charge-discharge curve is obtained. The result indicates that the relationship between the charge-discharge voltage and battery capacity is uniquely determined and, therefore, the state of charge (SOC) of the battery can be known and adjusted by detecting the voltage. This result is advantageous for controlling the lithium secondary battery. By contrast, with a combination of a positive electrode active material that is of the p type during charging and an n-type semiconductor substrate, there is no charge or discharge, as shown in FIG. 2, or the operating voltage is low, as shown in FIG. 3.

What is claimed is:

1. A lithium secondary battery comprising:
a positive electrode comprising a positive electrode active material; and
a semiconductor substrate that is directly laminated on the positive electrode, wherein
a charge carrier formed in the positive electrode active material when the lithium secondary battery is charged and a carrier of the semiconductor substrate are the same, and the semiconductor substrate is used as a collector.

2. The lithium secondary battery according to claim 1, wherein the charge carrier formed in the positive electrode active material when the lithium secondary battery is charged and the carrier of the semiconductor substrate are of the p type.

3. The lithium secondary battery according to claim 2, wherein
the positive electrode active material is LiMn₂O₄.

4. The lithium secondary battery according to claim 2, wherein
the positive electrode active material is LiCoO₂.

5. The lithium secondary battery according to claim 2, wherein
the semiconductor substrate is a p-type silicon semiconductor.

6. The lithium secondary battery according to claim 1, wherein
the laminated positive electrode active material has a thickness in the range of 0.1 μm to 100 μm.

7. The lithium secondary battery according to claim 6, wherein
the laminated positive electrode active material has a thickness in the range of 1 μm to 50 μm.

8. The lithium secondary battery according to claim 1, further comprising:
an electrolyte layer that is formed on the positive electrode on a side opposite that of the semiconductor substrate;
a negative electrode formed on the electrolyte layer on a side opposite that of the positive electrode; and
a negative electrode collector formed on the negative electrode on a side opposite that of the electrolyte layer.

9. A method for manufacturing the lithium secondary battery according to claim 8, comprising:
laminating the positive electrode on the semiconductor substrate;
laminating an electrolyte layer on the positive electrode;
laminating a negative electrode on the electrolyte layer; and
laminating a negative electrode collector on the negative electrode.

10. The manufacturing method according to claim 9, wherein
a thin film of the positive electrode is laminated on the semiconductor substrate through pulsed laser deposition.

11. The manufacturing method according to claim 10, wherein
the pulsed laser deposition is performed at a laser power of 180 mJ.

12. The manufacturing method according to claim 10, wherein
the pulsed laser deposition is performed under an O₂ atmosphere.

13. The manufacturing method according to claim 10, wherein
the pulsed laser deposition is performed at a pressure of 0.025 Torr.

14. The manufacturing method according to claim 10, wherein
the pulsed laser deposition is performed at a substrate temperature of 650° C.

15. The manufacturing method according to claim 9, wherein
the positive electrode is sintered at the same time as the positive electrode is laminated on the semiconductor substrate.

16. The manufacturing method according to claim 9, wherein
the positive electrode is sintered after the positive electrode has been laminated on the semiconductor substrate.

17. The manufacturing method according to claim 15, wherein
the positive electrode is sintered for 1 hour to 24 hours.

18. The manufacturing method according to claim 15, wherein
the positive electrode is sintered at 650° C. to 800° C.

19. The manufacturing method according to claim 15, wherein
the positive electrode is sintered at 700° C. to 800° C.
